(19) United States
(12) Patent Application Publication
(10) Pub. No.: US 2002/0151200 A1
(43) Pub. Date: Oct. 17, 2002

(54) Device for protecting an electric and/or electronic component arranged on a carrier substrate against electrostatic discharges

(76) Inventors: Edwin Fauser, Ditzingen (DE); Herman Roozenbeek, Schwieberdingen (DE); Wolfgang Schilling, Schwieberdingen (DE); Hans Seitel, Esslingen (DE); Thomas Wizemann, Ludwigsburg (DE); Reinhard Pfendtner, Bietigheim-Bissingen (DE); Werner Butschkau, Bietigheim-Bissingen (DE); Wolfgang Hiller, Bietigheim-Bissingen (DE); Stefan Josten, Remscheid (DE)

Correspondence Address: KENYON & KENYON, ONE BROADWAY, NEW YORK, NY, 10004, US

(21) Appl. No.: 10/030,866

(22) PCT Filed: Feb. 10, 2001
(86) PCT No.: PCT/DE01/00512

(30) Foreign Application Priority Data
Feb. 18, 2000 (DE) 100 06 787.5
Dec. 23, 2000 (DE) 100 65 019.8

(51) Int. Cl. H01R 13/53

(52) U.S. Cl. 439/181

(57) ABSTRACT

The proposal relates to a device for protecting an electrical and/or electronic component, arranged on a carrier substrate, from electrostatic discharges, an overvoltage occurring in the case of discharge at a carrier-substrate contact element connected to the component being diverted to a ground connection, bypassing the component. It is proposed that the protective device include a first electroconductive structure conductively connected to the jeopardized contact element, and a second electroconductive structure arranged adjacent to the first structure on the carrier substrate and conductively connected to the ground connection. Mutually facing sections of the electroconductive structures are set apart spatially from one another by a defined gap in such a way that an overvoltage transmitted to the contact element is transferred by a spark discharge in the gap from the section of the first electroconductive structure to the section of the second electroconductive structure, and is diverted to the ground connection.

### FIELD OF THE INVENTION

The present invention relates to a device for protecting an electrical and/or electronic component, arranged on a carrier substrate, from electrostatic discharges. Such devices are also known as ESD protective devices (ESD=electrostatic discharge).

### BACKGROUND INFORMATION

In the course of inadvertent touching of contact elements of the carrier substrate, or when putting a male connector on the contact elements, or after installation of the carrier substrate in an electrical device, electrostatic discharges may be created. ESD protective devices on carrier substrates are used to prevent electrostatic discharges and ESD pulses from being transferred to the sensitive electronic components of the carrier substrate that are connected to the contact elements in the event that connectors, cable harness and aggregates receive voltage. The discharge current is diverted to a ground connection by the ESD protective device before it can reach the components. Such an ESD protective device is discussed, for example, in U.S. Pat. No. 4,179,178. The protective device described therein includes a contact spring element that is mounted on the carrier substrate and, under prestressing, abuts against all contact elements of the carrier substrate, which are thereby initially short-circuited. Upon slipping on a male connector, the contact spring element is contacted to a ground contact of the male connector, and an electrostatic discharge current possibly occurring is diverted to ground. Upon further insertion of the male connector, the contact spring element is separated from the contact elements, and the plug contacts are subsequently slid onto the contact elements; in so doing, it is not possible to prevent overvoltages present at an individual plug pin from being transferred to the contact elements of the carrier substrate, and from there to the components. In addition, the entire design is relatively complicated mechanically and expensive.

Furthermore, ESD protective devices on printed-circuit-board substrates are known which electrically connect contacting printed circuit traces of electronic components, arranged on the printed-circuit board, via diodes, varistors or surge arresters to a ground connection. In the case of an electrostatic discharge transferred to a contacting printed circuit trace, the discharge current is then diverted via the varistors, diodes and surge arresters to ground. Such design approaches require that the printed-circuit board be fitted with additional components that take up space on the printed-circuit board, and make it necessary to change the layout of the printed circuit traces. In addition, production costs are thereby increased.

### SUMMARY OF THE INVENTION

The ESD protective device in accordance with the present invention permits an inexpensive and reliable protection of ESD-sensitive electrical and/or electronic components, particularly electronic circuits, on carrier substrates such as printed-circuit boards or ceramic multi-layer substrates. The ESD-protective device is relatively easy to produce, no costly special components being necessary. The device includes two electroconductive structures in which mutually facing sections of the electroconductive structures are spatially set apart from each other by a gap. The electroconductive structures are produced in a defined manner, such that an overvoltage transmitted to one contact element is transferred by a spark discharge in the gap between the sections and diverted to the ground connection. The gap width can be adjusted in such a way that, on the one hand, a galvanic contact of the electroconductive structures is reliably ruled out, and on the other hand, if a predefined voltage value is exceeded, a sparkover takes place to the electroconductive structure connected to the ground connection.

In principle, the electroconductive structures and the gap separating the conductive structures can be produced in widely differing manners. However, it is particularly advantageous to construct the electroconductive structures in the form of printed circuit traces which are configured on a shared main surface of the carrier substrate and which have mutually facing projections that are separated from each other by a gap produced in a defined manner. The printed circuit traces can be produced inexpensively on the main surface of the carrier substrate using known manufacturing methods. Because the mutually facing projections of the printed circuit traces taper in cross-section starting from the printed circuit traces, it is ensured that a defined sparkover takes place between the projection ends facing one another. In one advantageous exemplary embodiment, the projections taper essentially in the shape of a triangle and have pointed ends facing one another. The clearance between the pointed ends defines the gap width. Since here the spark discharge takes place directly on the surface of the carrier substrate, the disruptive discharge voltage in the gap is advantageously reduced by creeping spark discharges on the surface of the carrier substrate.

For example, the gap between the mutually facing projections of the conductive structures can be produced using etching techniques known from printed-circuit-board technology. It may be particularly advantageous if the gap between the mutually facing projections of the first and second electroconductive structures is produced by a laser cutting introduced into the printed-circuit-trace structures of the carrier substrate. Extremely small gaps can be made with great precision using the laser. In this way, it is possible to realize small gap widths to 20 micrometers, so that a sparkover takes place in the gap in the case of small disruptive discharge voltages. In addition, the formation time for the spark channel can thereby be minimized. Gap widths between 30 and 40 μm may be preferable.

In another advantageous exemplary embodiment, a multi-layer substrate is used as the carrier substrate.

In this embodiment the first electroconductive structure is formed by a first printed circuit trace configured on a main surface of the multi-layer substrate, and the second electroconductive structure is formed by a second printed circuit trace that is configured on an inner layer of the multi-layer substrate and is separated from the first printed circuit trace by an insulating plane. A blind-hole-type opening is introduced into the first printed circuit trace and the insulating plane by etching, boring or in another manner, the second printed circuit trace forming the bottom of the opening. In this exemplary embodiment, for example, it may be possible to utilize manufacturing techniques known from the manufacture of ceramic multi-layer substrates or multi-layer printed-circuit boards. In this case, the gap between the first and the second structure is defined by the thickness of the insulating layer arranged between the first and the second structure. The sparkover may take place within the air-filled, blind-hole-type opening, starting from the printed-circuit-trace section of the first structure surrounding the opening at the upper edge, and proceeding to the printed-circuit-trace section of the second structure which forms the bottom of the opening.

In another exemplary embodiment having a multi-layer substrate, the first electroconductive structure is formed by a first printed circuit trace configured on an arbitrary first layer of the multi-layer substrate, and the second electroconductive structure is formed by a second printed circuit trace that is configured on a second layer of the multi-layer substrate and is separated from the first printed circuit trace by an insulating plane. An opening, particularly a bore hole penetrating the multi-layer substrate, is introduced into the first printed circuit trace, the insulating plane and the second printed circuit trace. A spark discharge may take place in the gap, formed by the opening, between the inner-wall sections of the first and second printed circuit traces.

The second printed circuit trace may also be advantageously formed by a large-area earth plane of the multi-layer substrate, e.g. a continuous copper layer.

In another exemplary embodiment, the electroconductive structures are formed by two discrete conductor elements that project from the carrier substrate and are conductively connected to printed circuit traces of the carrier substrate. The ends of the conductor elements not connected to the carrier substrate face one another and are separated from one another by a defined gap. The spark discharge then comes about in the air gap between the ends of the conductor elements. It may be that this design approach is somewhat more complicated than the integration of the structures into the printed circuit traces of the carrier substrate. However, discrete conductor elements, such as metallic contact pins, exhibit great stability with respect to environmental influences, so that fluctuations in the gap width caused by environmental influences are negligibly small.

Furthermore, mixed forms are also possible in which the first electroconductive structure is in the form of a conductor element that, with a first end, is connected to a contact element, e.g. a contact pin, which is jeopardized by discharge currents, which projects from the carrier substrate and which is connected to printed circuit traces of the carrier substrate. A further end of the conductor element faces a second electroconductive structure in the form of a printed circuit trace configured on the carrier substrate and conductively connected to the grounding connection, and is set apart from this printed circuit trace by a gap.

Another exemplary embodiment provides for the mutually facing sections, separated by the definably produced gap, of two printed circuit traces configured on the side of the carrier substrate fitted with components may be overlapped by an additional active or passive electrical component applied on the carrier substrate. The component covering the gap advantageously protects it from impurities and the deposit of conductive particles which could cause a short circuit between the two printed circuit traces. The active or passive component can be parallel-connected with respect to the discharge path, by electroconductively connecting a first terminal of the component to the first printed circuit trace jeopardized by a possibly occurring overvoltage, and electroconductivley connecting a second terminal of the component to the second printed circuit trace connected to the ground connection. Furthermore, to protect the discharge gap, the component may be joined in its edge area to the carrier substrate by an adhesive agent which seals the interspace between the component and the carrier substrate.

### BRIEF DESCRIPTION OF THE DRAWINGS

FIG. 1 shows a top view of a first exemplary embodiment of the invention having a protective device against electrostatic discharges which is formed by printed circuit traces on a main surface of a carrier substrate.

FIGS. 2a and 2b show an exemplary embodiment in which the gap is introduced into the printed-circuit-trace structure of a carrier substrate by a laser.

FIG. 3 shows an exemplary embodiment of the ESD protective device having two discrete conductor elements.

FIG. 4 shows an exemplary embodiment having one conductor element and one printed circuit trace.

FIG. 5 shows an exemplary embodiment for a multi-layer substrate having a blind-hole-type opening.

FIG. 6 shows an exemplary embodiment for a multi-layer substrate having an opening passing straight through.

FIG. 7 shows a top view of a further exemplary embodiment of the invention having an active or passive electrical component arranged above the discharge gap.

FIG. 8 shows a cross-section through the exemplary embodiment shown in FIG. 7.

### DETAILED DESCRIPTION

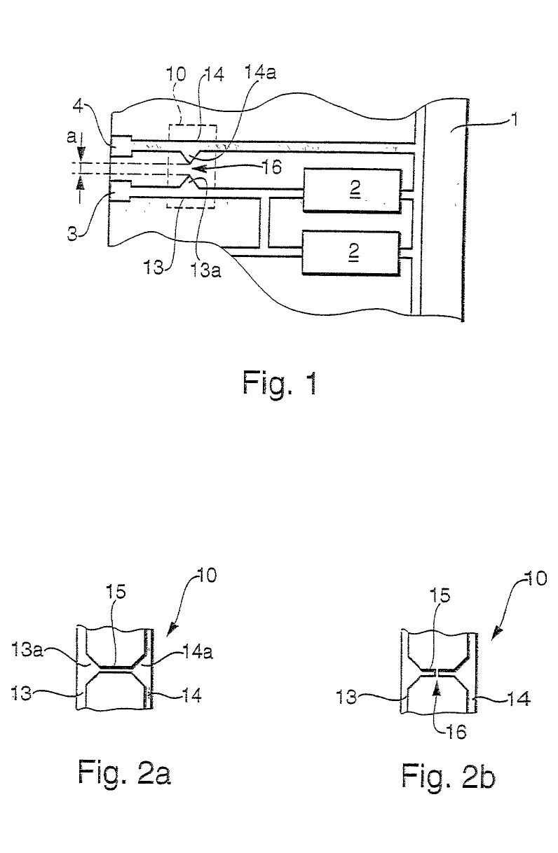

FIG. 1 shows a top view of the surface of a printed-circuit board 1, upon which a plurality of electrical and/or electronic components 2, e.g. microprocessors, storage components, semi-conductor chips, resistance components, inductive components or others are arranged. Printed-circuit board 1 is provided on one side with contact areas 3, 4 which are used for connecting the printed-circuit board to a male connector, contact area 3 being provided, for example, for the connection of a signal line, and contact area 4 being provided for the connection of a grounding contact to printed-circuit board 1. As FIG. 1 further shows, contact area 3 is connected via a printed circuit trace 13 to the input of a component 2. Contact area 4 is connected via a further printed circuit trace 14 to the grounding contact of components 2. Grounding printed circuit trace 14 does not necessarily have to be connected to the grounding contact of components 2. Grounding printed circuit trace 14 may be any printed circuit trace which is connected via contact element 4 to ground. In this context, a ground connection is understood to be a connection to a conductor suitable for diverting discharge currents. This may also be a metallic housing part, or even a supply line capable of diverting overvoltages. Formed on printed circuit traces 13, 14, which are adjacently configured on printed-circuit board 1, are mutually facing projections 13a, 14a, that are set apart from each other by a narrow gap 16. As can be seen, the projections taper in the shape of a triangle starting from printed circuit traces 13, 14, and have pointed ends whose clearance “a” defines the gap width. The region of printed circuit traces 13, 14, provided with projections 13a, 14a and gap 16, forms on the printed-circuit board a device 10 for protecting against electrostatic discharges. If, for example, contact areas 3 come into contact with an electrostatically charged mating connector or another charge carrier, then the charges flow from there to projection 13a. As soon as the voltage exceeds the necessary breakdown voltage, the overvoltage discharges through a sparkover, occurring partially as a creeping discharge process, to projection 14a, and from there to ground connection 4. The electrostatic discharge current can no longer reach components 2. Damage is thereby avoided. Without the ESD protective device, the discharge current would be transmitted unhindered via printed circuit trace 13 to components 2. Instead of the printed-circuit board shown here, naturally another carrier substrate can also be used, e.g. a ceramic thick-film substrate, an extrusion-coated stamped grid or an MID substrate. In the exemplary embodiment of FIG. 1, gap “a” between electroconductive structures 13, 14 can be produced by the etching method known from printed-circuit-board production. However, gap widths “a” of less than 100 μm may not be able to be implemented by this method. In one preferred exemplary embodiment shown in FIGS. 2a and 2b, the gap is therefore produced using a laser. For this purpose, as shown in FIG. 2a, the printed-circuit-trace structures are first of all produced on the printed-circuit board by the customary etching technique. In so doing, printed circuit trace 13 is initially connected to printed circuit trace 14 by a narrow printed-circuit-trace web 15. Subsequently, as shown in FIG. 2b, a gap 16 is produced in web 15 by a laser cut, the gap separating printed circuit traces 13 and 14 from each other. Gap widths “a” of 20 μm may be implemented using the laser. In a preferred specific embodiment, the gap width is 30 to 40 μm.

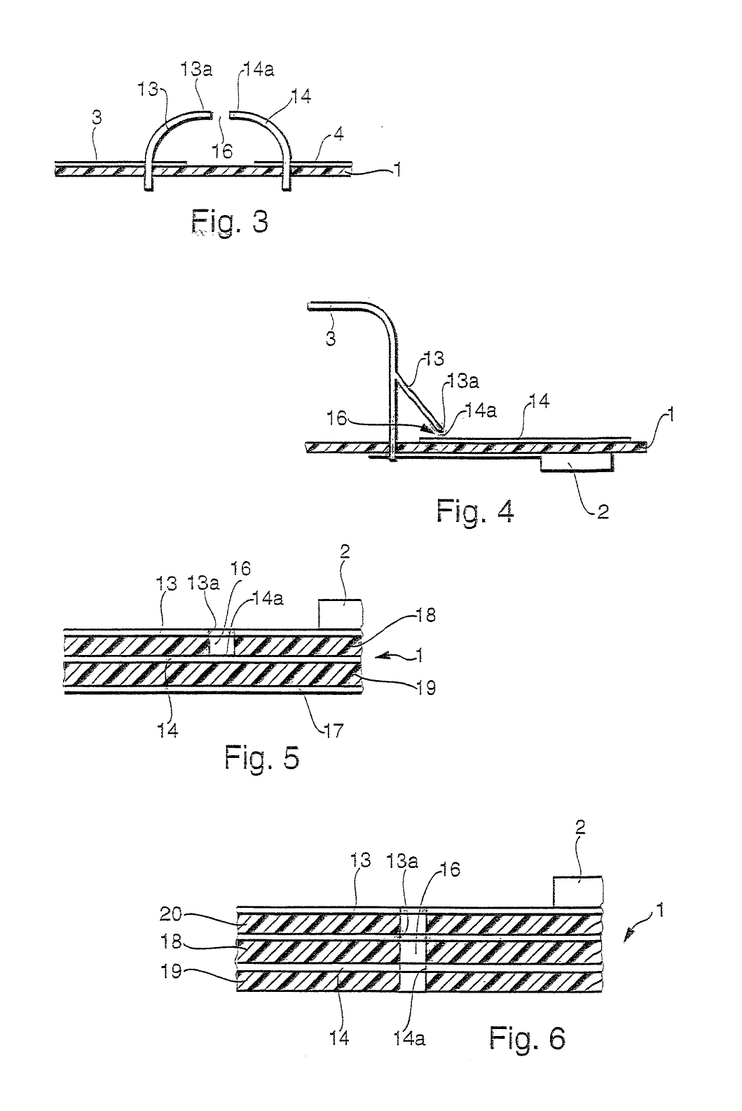

In the exemplary embodiments shown in FIGS. 1 and 2, the first and second electroconductive structures are produced by printed circuit traces 13, 14 on a carrier substrate. However, other exemplary embodiments are also possible. FIG. 3 shows a cross-section through a printed-circuit board 1 having contact areas 3, 4. Contact area 3 is connected, in a manner not shown, to an ESD-sensitive component on the printed-circuit board. Contact area 4 is connected to a ground connection. As FIG. 3 shows, the electroconductive structures are formed by two conductor elements 13, 14 projecting from the printed-circuit board. The conductor elements are secured as curved metal wires in openings in the printed-circuit board and are conductively connected to contact areas 3, 4. Mutually facing ends 13a, 14a of the metal wires are set apart from each other by an air gap 16. In the event of discharge, the overvoltage applied to conductor element 13 discharges through a spark discharge in air gap 16 to conductor element 14, and flows off from there to ground.

A further exemplary embodiment is depicted in FIG. 4. FIG. 4 shows a printed-circuit board 1 having a connector pin 3 which is introduced in the usual manner into a contact opening in the printed-circuit board and is soldered to a printed circuit trace on the bottom side of the printed-circuit board, which in turn is connected to an electronic component 2. Branching off from connector pin 13 at half height is a pin-shaped conductor element 13 which, with its one end, is joined in one piece with connector pin 3, and with its other end 13a facing away from the connector pin, is directed toward the top side of printed-circuit board 1. A grounding printed circuit trace 14 is configured on the top side of the printed-circuit board. End 13a of conductor element 13 is positioned directly above a region 14a of printed circuit trace 14 and is separated by an air gap 16 from region 14a. An electrostatic discharge, transferred when inserting a mating connector onto connector pin 3, is transferred by a spark discharge in gap 16 from conductor element 13 to printed circuit trace 14.

In the exemplary embodiment shown in FIG. 5, a multi-layer printed-circuit board or a ceramic multi-layer substrate is used as carrier substrate 1. A printed circuit trace 13 on the top side of carrier substrate 1 connects an ESD-sensitive component 2 to a contact element (not shown) of the carrier substrate, e.g. a plug pin. An inner layer 14 of the multi-layer substrate may be constructed as a large-area earth plane. Earth plane 14 may be separated by an insulating layer 18 from printed circuit trace 13 on the top side. A further insulating layer 19 separates the earth plane from a printed circuit trace 17 on the bottom side of the multi-layer substrate. A blind-hole-type opening is introduced into printed circuit trace 13 and insulating layer 18. Bottom 14a of the blind-hole-type opening is formed by earth plane 14. In the event of an overvoltage transferred to printed circuit trace 13, the overvoltage is also applied to inner edge 13a of printed circuit trace 13 which surrounds the opening and which is separated from bottom 14a by a gap 16. The overvoltage is diverted to ground by a sparkover from edge 13a to bottom 14a of grounding printed circuit trace 14 before it can reach component 2. The width of the gap between the edge of printed circuit trace 13a and bottom 14a of opening 16a is defined by the thickness of insulating layer 18.

A similar exemplary embodiment for a multi-layer printed-circuit board is shown in FIG. 6. Multi-layer printed-circuit board 1 includes insulating layers 18, 19, 20 and conductor layers. Configured on two inner adjacent layers are a first printed circuit trace 13 and a second printed circuit trace 14 which are separated by insulating layer 18. Printed circuit traces 13, 14 can be arranged on any adjacent layers. As above, printed circuit trace 13 is connected to an ESD-sensitive component 2, and printed circuit trace 14 is connected to the ground connection. A continuous bore hole is introduced into the multi-layer substrate in the region of printed circuit traces 13, 14. Inner edge 13a of printed circuit trace 13 surrounding the bore hole and inner edge 14a of printed circuit trace 14 are separated by an air gap 16 produced by the bore hole in insulating layer 18. In the event of overvoltage, an ESD pulse discharges from inner edge 13a of first printed circuit trace 13 through air gap 16 to inner edge 14a of second printed circuit trace 14.

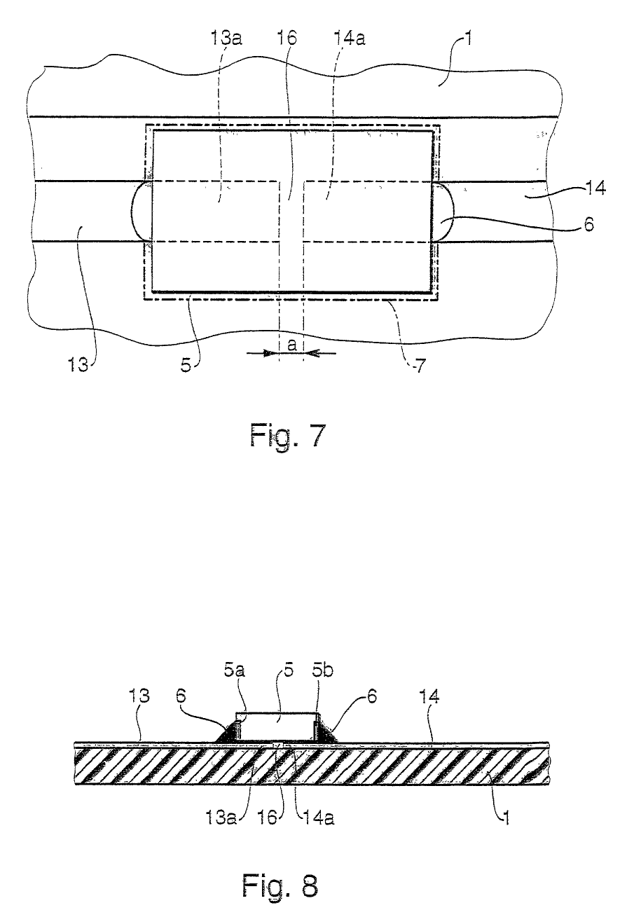

A further exemplary embodiment of the invention is shown in the cut-away portion of FIGS. 7 and 8. A carrier substrate 1, e.g. a printed-circuit board, has on the top side two printed circuit traces 13, 14 which are separated by a narrow gap 16. Printed circuit traces 13, 14 can initially be produced as a common printed circuit trace on the carrier substrate and subsequently be separated by a laser cutting, so that adjacent end sections 13a and 14a of the printed circuit traces are set apart from each other by gap of dimension “a”. Printed circuit trace 13 is connected to an ESD-sensitive component in a manner not shown; printed circuit trace 14 is connected to a ground connection. To protect gap 16, an active or passive electrical component 5, e.g. a capacitor or resistor, is applied over sections 13a, 14a and gap 16 on the printed circuit traces. In principle, the exemplary embodiment shown here is formed in that, from FIG. 1, an additional component 5 is applied on printed circuit traces 13 and 14. Naturally, in contrast to ESD-sensitive component 2, component 5 is a component insensitive to an ESD pulse. For example, component 5 may be an EMC-protective capacitor. In one preferred specific embodiment, component 5 may be applied on the carrier substrate using SMD (surface mounted device) technology. A first connecting terminal 5a of the component may be soldered to printed circuit trace 13, a second connecting terminal 5b may be soldered to printed circuit trace 14, so that component 5 is parallel-connected with respect to the spark gap. Soldering points 6 are shown in FIGS. 7 and 8. For example, the component may be soldered using the reflow soldering method or in another suitable manner. However, it may also be possible to electrically connect the component to printed circuit traces 13, 14 via bonding wires. An adhesive agent 7 may be applied in the edge area of component 5. The adhesive agent may be applied circumferentially, which means soldering points 6 can be omitted. The intervening space between component 5 and carrier substrate 1 may be sealed by adhesive agent 7. Impurities may thereby be excluded from penetrating into the intervening space between the component and the carrier substrate and getting into gap 16. This exemplary embodiment may offer advantageous protection against contamination of gap 16 and the spark path of a possible ESD discharge. DEVICE FOR PROTECTING AN ELECTRICAL AND/OR ELECTRONIC COMPONENT, ARRANGED ON A CARRIER SUBSTRATE, FROM ELECTROSTATIC DISCHARGES

Background Information The present invention relates to a device for protecting an electrical and/or electronic component, arranged on a carrier substrate, from electrostatic discharges, having the features indicated in the preamble of claim 1. Such devices are also known in the technical world as ESD protective devices (ESD =electrostatic discharge). For example, given inadvertent touching of contact elements of the carrier substrate, or when putting a male connector on the contact elements, or after installation of the carrier substrate in an electrical device, ESD protective devices on carrier substrates are used to prevent electrostatic discharges and ESD pulses from being transferred to the sensitive electronic components of the carrier substrate that are connected to the contact elements, in the event connectors, cable harness and aggregates receive voltage. The discharge current is diverted to a ground connection by the ESD protective device before it can reach the components. Such an ESD protective device, corresponding to the preamble of claim 1, is known, for example, from the U.S. Pat. No. 4,179,178.

The protective device described there includes a contact spring element that is mounted on the carrier substrate and, under prestressing, abuts against all contact elements of the carrier substrate, which are thereby initially short-circuited. Upon slipping on a male connector, the contact spring element is contacted to a ground contact of the male connector, and an 415836 electrostatic discharge current possibly occurring is diverted to ground. Upon further insertion of the male connector, the contact spring element is separated from the contact elements, and the plug contacts are subsequently slid onto the contact elements; in so doing, it is not possible to prevent overvoltages present at an individual plug pin from being transferred to the contact elements of the carrier substrate, and from there to the components. In addition, the entire design is relatively complicated mechanically and expensive.

Furthermore, ESD protective devices on printed-circuitboard substrates are known which electrically connect contacting printed circuit traces of electronic components, arranged on the printed-circuit board, via diodes, varistors or surge arresters to a ground connection. In the case of an electrostatic discharge transferred to a contacting printed circuit trace, the discharge current is then diverted via the varistors, diodes and surge arresters to ground. Such design approaches require that the printed-circuit board be fitted with additional components that take up space on the printed-circuit board, and make it necessary to change the layout of the printed circuit traces. In addition, production costs are thereby increased.

### SUMMARY OF THE INVENTION

The ESD protective device having the characterizing features of claim 1 permits an inexpensive and reliable protection of ESD-sensitive electrical and/or electronic components, particularly electronic circuits, on carrier substrates such as printed-circuit boards or ceramic multi-layer substrates. The ESD-protective device is relatively easy to produce, no costly special components 415836 -2being necessary. The device includes merely two electroconductive structures, mutually facing sections of the electroconductive structures being spatially set apart from each other by a gap, produced in a defined manner, such that an overvoltage transmitted to one contact element is transferred by a spark discharge in the gap between the sections and diverted to the ground connection. The gap width can be adjusted in such a way that, on one hand, a galvanic contact of the electroconductive structures is reliably ruled out, and on the other hand, if a predefined voltage value is exceeded, a sparkover takes place to the electroconductive structure connected to the ground connection. Advantageous refinements and further developments of the invention are made possible by the features contained in the dependent claims. In principle, the electroconductive structures and the gap separating the conductive structures can be produced in widely differing manners. However, it is particularly advantageous to construct the electroconductive structures in the form of printed circuit traces which are configured on a shared main surface of the carrier substrate and which have mutually facing projections that are separated from each other by a gap produced in a defined manner. The printed circuit traces can be produced inexpensively on the main surface of the carrier substrate using known manufacturing methods. Because the mutually facing projections of the printed circuit traces taper in cross-section starting from the printed circuit traces, it is ensured that a defined sparkover takes place between the projection ends facing one another. In one advantageous exemplary embodiment, the projections 415836 -3taper essentially in the shape of a triangle and have pointed ends facing one another. The clearance between the pointed ends defines the gap width. Since here, the spark discharge takes place directly on the surface of the carrier substrate, the disruptive discharge voltage in the gap is advantageously reduced by creeping spark discharges on the surface of the carrier substrate.

For example, the gap between the mutually facing projections of the conductive structures can be produced using etching techniques known from printed-circuit-board technology. It is particularly advantageous if the gap between the mutually facing projections of the first and second electroconductive structures is produced by a laser cutting introduced into the printed-circuit-trace structures of the carrier substrate. Extremely small gaps can be made with great precision using the laser. In this way, it is possible to realize small gap widths to 20 micrometers, so that a sparkover already takes place in the gap in the case of small disruptive discharge voltages. In addition, the formation time for the spark channel can thereby be minimized. Gap widths between 30 and 40 Am are preferable. In another advantageous exemplary embodiment, a multi-layer substrate is used as the carrier substrate, the first electroconductive structure being formed by a first printed circuit trace configured on a main surface of the multi-layer substrate, and the second electroconductive structure being formed by a second printed circuit trace that is configured on an inner layer of the multi-layer substrate and is separated from the first printed circuit trace by an insulating plane;

and a blind-hole-type opening is introduced into the first printed circuit trace and the insulating plane by 415836 -4etching, boring or in another manner, the second printed circuit trace forming the bottom of the opening. In this exemplary embodiment, for example, it is possible to fall back to a great extent on manufacturing techniques known from the manufacture of ceramic multi-layer substrates or multi-layer printed-circuit boards, without a fundamental change being necessary. In this case, the gap between the first and the second structure is defined by the thickness of the insulating layer arranged between the first and the second structure. The sparkover takes place within the air-filled, blind-hole-type opening, starting from the printed-circuit-trace section of the first structure surrounding the opening at the upper edge, to the printed-circuit-trace section of the second structure forming the bottom of the opening.

In a further similar exemplary embodiment having a multi-layer substrate, the first electroconductive structure is formed by a first printed circuit trace configured on an arbitrary first layer of the multi-layer substrate, and the second electroconductive structure is formed by a second printed circuit trace that is configured on a second layer of the multi-layer substrate and is separated from the first printed circuit trace by an insulating plane; and an opening, particularly a bore hole, penetrating the multi-layer substrate is introduced into the first printed circuit trace, the insulating plane and the second printed circuit trace, a spark discharge taking place in the gap, formed by the opening, between the inner-wall sections of the first and second printed circuit traces.

The second printed circuit trace can advantageously be formed by a large-area earth plane of the multi-layer substrate, e.g. a continuous copper layer. 415836 -5

In another exemplary embodiment, the electroconductive structures are formed by two discrete conductor elements that project from the carrier substrate and are conductively connected to printed circuit traces of the carrier substrate, the ends of the conductor elements not connected to the carrier substrate facing one another and being separated from one another by a defined gap. The spark discharge then comes about in the air gap between the ends of the conductor elements. It may be that this design approach is somewhat more complicated than the integration of the structures into the printed circuit traces of the carrier substrate; however, discrete conductor elements, such as metallic contact pins, exhibit great stability with respect to environmental influences, so that fluctuations in the gap width caused by environmental influences are negligibly small.

Furthermore, mixed forms are also possible in which the first electroconductive structure is in the form of a conductor element that, with a first end, is connected to a contact element, e.g. a contact pin, which is jeopardized by discharge currents, projects from the carrier substrate and is connected to printed circuit traces of the carrier substrate; and that with a further end of the conductor element faces a second electroconductive structure in the form of a printed circuit trace configured on the carrier substrate and conductively connected to the grounding connection, and is set apart from this printed circuit trace by a gap.

Particularly advantageous is an exemplary embodiment in which the mutually facing sections, separated by the definably produced gap, of two printed circuit traces configured on the side of the carrier substrate fitted with components are overlapped by an additional active or 415836 -6passive electrical component applied on the carrier substrate. The component covering the gap advantageously protects it from impurities and the deposit of conductive particles which could cause a short circuit between the two printed circuit traces. The active or passive component can be parallel-connected with respect to the discharge path, by electroconductively connecting a first terminal of the component to the first printed circuit trace jeopardized by a possibly occurring overvoltage, and electroconductivley connecting a second terminal of the component to the second printed circuit trace connected to the ground connection. Furthermore, to protect the discharge gap, the component can be joined in its edge area to the carrier substrate by an adhesive agent which seals the interspace between the component and the carrier substrate.

### BRIEF DESCRIPTION OF THE DRAWINGS

Exemplary embodiments of the invention are explained in the following description and are shown in the Drawing, in which: FIG. 1 shows a top view of a first exemplary embodiment of the invention having a protective device against electrostatic discharges which is formed by printed circuit traces on a main surface of a carrier substrate; FIGS. 2a and 2b show an exemplary embodiment in which the gap is introduced into the printed-circuit-trace structure of a carrier substrate by a laser; FIG. 3 shows an exemplary embodiment of the ESD protective device having two discrete conductor elements; 415836 -7FIG. shows an exemplary embodiment having one conductor element and one printed circuit trace; FIG. 5 shows an exemplary embodiment for a multi-layer substrate having a blind-hole-type opening; FIG. 6 shows an exemplary embodiment for a multi-layer substrate having an opening passing straight through; FIG. 7 shows a top view of a further exemplary embodiment of the invention having an active or passive electrical component arranged above the discharge gap; FIG. 8 shows a cross-section through FIG. 7. Description of the Exemplary Embodiments FIG. 1 shows a top view of the surface of a printed-circuit board 1, upon which a plurality of electrical and/or electronic components 2, e.g. microprocessors, storage components, semi-conductor chips, resistance components, inductive components or others are arranged. Printed-circuit board 1 is provided on one side with contact areas 3, 4 which are used for connecting the printed-circuit board to a male connector, contact area 3 being provided, for example, for the connection of a signal line, and contact area 4 being provided for the connection of a grounding contact to printed-circuit board 1. As FIG. 1 further shows, contact area 3 is connected via a printed circuit trace to the input of a component 2. Contact area 4 is connected via a further printed circuit trace 14 to the grounding contact of components 2. Grounding printed circuit trace 14 does not necessarily have to be connected to the grounding contact of components 2. Here, 415836 -8it can be any printed circuit trace which is connected via contact element 4 to ground. In this context, understood by a ground connection is the connection to a conductor suitable for diverting discharge currents. This can also be a metallic housing part, or even a supply line capable of diverting overvoltages. Formed on printed circuit traces 13, 14, which are adjacently configured on printed-circuit board 1, are mutually facing projections 13a, 14a, that are set apart from each other by a narrow gap 16. As can be seen, the projections taper in the shape of a triangle starting from printed circuit traces 13, 14, and have pointed ends whose clearance “a” defines the gap width. The region of printed circuit traces 13, provided with projections 13a, 14a and gap 16 forms on the printed-circuit board a device 10 for protecting against electrostatic discharges. If, for example, contact areas 3 come into contact with an electrostatically charged mating connector or another charge carrier, then the charges flow from there to projection 13a. As soon as the voltage exceeds the necessary breakdown voltage, the overvoltage discharges through a sparkover, occurring partially as a creeping discharge process, to projection 14a, and from there to ground connection 4. The electrostatic discharge current can no longer reach components 2. Damage is thereby avoided. Without the ESD protective device, the discharge current would be transmitted unhindered via printed circuit trace 13 to components 2. Instead of the printed-circuit board shown here, naturally another carrier substrate can also be used, e.g. a ceramic thick-film substrate, an extrusion-coated stamped grid or an MID substrate. In the exemplary embodiment of FIG. 1, gap “a” between electroconductive structures 13, 14 can be produced by the etching method known from printed-circuit-board production. However, gap widths “a” 415836 -9of less than 100 Am can scarcely be implemented by this means. In one preferred exemplary embodiment shown in FIGS. 2a and 2b, the gap is therefore produced using a laser. For this purpose, as shown in FIG. 2a, the printed-circuit-trace structures are first of all produced on the printed-circuit board by the customary etching technique. In so doing, printed circuit trace 13 is initially connected to printed circuit trace 14 by a narrow printed-circuit-trace web 15. Subsequently, as shown in FIG. 2b, a gap 16 is produced in web 15 by a laser cut, the gap separating printed circuit traces 13 and 14 from each other. Gap widths “a” of 20 Am can be implemented using the laser. In the preferred specific embodiment, the gap width is 30 to 40 Am. 15=In the exemplary embodiments shown in FIGS. 1 and 2, the first and second electroconductive structures are produced by printed circuit traces 13, 14 on a carrier substrate. However, other exemplary embodiments are also possible. FIG. 3 shows a cross-section through a printed-circuit board 1 having contact areas 3, 4.

Contact area 3 is connected, in a manner not shown, to an ESD-sensitive component on the printed-circuit board.

Contact area 4 is connected to a ground connection. As FIG. 3 shows, the electroconductive structures are formed by two conductor elements 13, 14 projecting from the printed-circuit board. The conductor elements are secured as curved metal wires in openings in the printed-circuit board and are conductively connected to contact areas 3, 4. Mutually facing ends 13a, 14a of the metal wires are set apart from each other by an air gap 16. In the event of discharge, the overvoltage applied to conductor element 13 discharges through a spark discharge in air gap 16 to conductor element 14, and flows off from there to ground. 415836 -10

A further exemplary embodiment is depicted in FIG. 4.

FIG. 4 shows a printed-circuit board 1 having a connector pin 3 which is introduced in the usual manner into a contact opening in the printed-circuit board and is soldered to a printed circuit trace on the bottom side of the printed-circuit board, which in turn is connected to an electronic component 2. Branching off from connector pin 13 at half height is a pin-shaped conductor element 13 which, with its one end, is joined in one piece with connector pin 3, and with its other end 13a facing away from the connector pin, is directed toward the top side of printed-circuit board 1. A grounding printed circuit trace 14 is configured on the top side of the printed-circuit board. End 13a of conductor element 13 is positioned directly above a region 14a of printed circuit trace 14 and is separated by an air gap 16 from region 14a. An electrostatic discharge, transferred when inserting a mating connector onto connector pin 3, is transferred by a spark discharge in gap 16 from conductor element 13 to printed circuit trace 14.

In the exemplary embodiment shown in FIG. 5, a multi-layer printed-circuit board or a ceramic multi-layer substrate is used as carrier substrate 1. A printed circuit trace 13 on the top side of carrier substrate 1 connects an ESD-sensitive component 2 to a contact element (not shown) of the carrier substrate, e.g. a plug pin. An inner layer 14 of the multi-layer substrate is constructed as a large-area earth plane. Earth plane 14 is separated by an insulating layer 18 from printed circuit trace 13 on the top side. A further insulating layer 19 separates the earth plane from a printed circuit trace 17 on the bottom side of the multi-layer substrate. A blind-hole-type opening is introduced into printed circuit trace 13 and insulating 415836 -111ayer 18. Bottom 14a of the blind-hole-type opening is formed by earth plane 14. In the event of an overvoltage transferred to printed circuit trace 13, the overvoltage is also applied to inner edge 13a of printed circuit trace 13 which surrounds the opening and which is separated from bottom 14a by a gap 16. The overvoltage is diverted to ground by a sparkover from edge 13a to bottom 14a of grounding printed circuit trace 14 before it can reach component 2. The width of the gap between the edge of printed circuit trace 13a and bottom 14a of opening 16a is defined by the thickness of insulating layer 18.

A similar exemplary embodiment for a multi-layer printed-circuit board is shown in FIG. 6. Multi-layer printed-circuit board 1 includes insulating layers 18, 19, 20 and conductor layers. Configured on two inner adjacent layers are a first printed circuit trace 13 and a second printed circuit trace 14 which are separated by insulating layer 18. Printed circuit traces 13, 14 can be arranged on any adjacent layers. As above, printed circuit trace 13 is connected to an,ESD-sensitive component 2, and printed circuit trace 14 is connected to the ground connection. A continuous bore hole is introduced into the multi-layer substrate in the region of printed circuit traces 13, 14. Inner edge 13a of printed circuit trace 13 surrounding the bore hole and inner edge 14a of printed circuit trace 14 are separated by an air gap 16 produced by the bore hole in insulating layer 18. In the event of overvoltage, an ESD pulse discharges from inner edge 13a of first printed circuit trace 13 through air gap 16 to inner edge 14a of second printed circuit trace 14.

A further exemplary embodiment of the invention is shown in the cut-away portion of FIGS. 7 and 8. A carrier 415836 -12substrate 1, e.g. a printed-circuit board, has on the top side two printed circuit traces 13, 14 which are separated by a narrow gap 16. Printed circuit traces 13, can initially be produced as a common printed circuit trace on the carrier substrate and subsequently be separated by a laser cutting, so that adjacent end sections 13a and 14a of the printed circuit traces are set apart from each other by gap pf dimension “a”.

Printed circuit trace 13 is connected to an ESD-sensitive component in a manner not shown; printed circuit trace 14 is connected to a ground connection. To protect gap 16, an active or passive electrical component 5, e.g. a capacitor or resistor, is applied over sections 13a, 14a and gap 16 on the printed circuit traces. In principle, the exemplary embodiment shown here is formed in that, in FIG. 1, an additional component 5 is applied on printed circuit traces 13 and 14. Naturally, different from ESD-sensitive component 2, component 5 is a component insensitive to an ESD pulse. For example, component 5 can be an EMC-protective capacitor. In one preferred specific embodiment, component 5 is applied on the carrier substrate using SMD (surface mounted device) technology.

A first connecting terminal 5a of the component is soldered to printed circuit trace 13, a second connecting terminal 5b is soldered to printed circuit trace 14, so that component 5 is parallel-connected with respect to the spark gap. Soldering points 6 are shown in FIGS. 7 and 8. For example, the component can be soldered using the reflow soldering method or in another suitable manner. However, it is also possible to electrically connect the component to printed circuit traces 13, 14 via bonding wires. An adhesive agent 7 is applied in the edge area of component 5. The adhesive agent can be applied circumferentially, which means soldering points 6 can be omitted. The intervening space between component 5 and carrier substrate 1 is sealed by adhesive agent 7. Impurities are thereby excluded from penetrating into the intervening space between the component and the carrier substrate and getting into gap 16. This exemplary embodiment offers advantageous protection against contamination of gap 16 and the spark path of a possible ESD discharge.

What is claimed is:

1. A device for protecting an electrical and/or electronic component, arranged on a carrier substrate, from electrostatic discharges, whereby in the case of discharge, an overvoltage occurring at a contact element (3) of the carrier substrate (1) connected to the component (2) is diverted to a ground connection (4), bypassing the component,
wherein the protective device (10) includes a first electroconductive structure (13) conductively connected to the jeopardized contact element (3), and a second electroconductive structure (14), arranged adjacent to the first structure on the carrier substrate (1) and conductively connected to the ground connection (4); mutually facing sections (13a, 14a) of the electroconductive structures (13, 14) being spatially set apart from each other by a gap (16), produced in a defined manner, in such a way that an overvoltage transmitted to the contact element (3) is transferred by a spark discharge in the gap (16) from the section (13a) of the first electroconductive structure (13) to the section (14a) of the second electroconductive structure (14), and is diverted to the ground connection (4).

2. The device as recited in claim 1, wherein the first and second electroconductive structures (13, 14) are formed by printed circuit traces which are configured on a shared main surface of the carrier substrate (1) and which have mutually facing projections (13a, 14a) that are separated from each other by a gap (16) produced in a defined manner. (FIG. 1, 2a, 2b)

3. The device as recited in claim 2, wherein the mutually facing projections (13a, 14a) of the printed circuit traces taper in cross-section starting from the printed circuit traces (13, 14). (FIG. 1)

4. The device as recited in claim 3, wherein the projections (13a, 14a) taper essentially in the shape of a triangle and have pointed ends facing one another.

5. The device as recited in one of claims 2 through 4, wherein the gap (16) between the mutually facing projections (13a, 14a) of the first and second electroconductive structures (13, 14) is produced by a laser cutting introduced into the printed-circuit-trace structures (15) of the carrier substrate (1). (FIG. 2a, 2b)

6. The device as recited in claim 1, wherein the carrier substrate (1) is a multi-layer substrate; the first electroconductive structure (13) is formed by a first printed circuit trace configured on a main surface of the multi-layer substrate, and the second electroconductive structure (14) is formed by a second printed circuit trace that is configured on an inner layer of the multi-layer substrate and is separated from the first printed circuit trace by an insulating plane (18); and a blind-hole-type opening, whose bottom is formed by the second printed circuit trace (14), is introduced into the first printed circuit trace (13) and the insulating plane (18), a spark discharge taking place in the gap (16), formed by the blind-hole-type opening, between the inner-wall section (13b) of the first printed circuit trace and the bottom (14b) of the opening. (FIG. 5)

7. The device as recited in claim 1, wherein the carrier substrate (1) is a multi-layer substrate; the first electroconductive structure (13) is formed by a first printed circuit trace configured on a first layer of the multi-layer substrate, and the second electroconductive structure (14) is formed by a second printed circuit trace that is configured on a second layer of the multi-layer substrate and is separated from the first printed circuit trace by an insulating plane (18); and an opening (16b), particularly a bore hole, penetrating the multi-layer substrate is introduced into the first printed circuit trace (13), the insulating plane (18) and the second printed circuit trace (14), a spark discharge taking place in the gap, formed by the opening (16b), between the inner-wall sections (13b, 14b) of the first and second printed circuit traces. (FIG. 6)

8. The device as recited in claim 6 or 7, wherein the second printed circuit trace (14) is formed by a large-area earth plane of the multi-layer substrate

9. The device as recited in claim 1, wherein the electroconductive structures (13, 14) are formed by two discrete conductor elements that project from the carrier substrate (1) and are conductively connected to printed circuit traces (3, 4) of the carrier substrate, the ends of the conductor elements not connected to the carrier substrate (1) facing one another and being separated from one another by a defined gap (16). (FIG. 3)

10. The device as recited in claim 1, wherein the first electroconductive structure (13) is in the form of a conductor element that, with a first end, is connected to a contact element (3) which is jeopardized by discharge currents, projects from the carrier substrate and is connected to printed circuit traces of the carrier substrate; and that the conductor element with a further end (13a) faces a second electroconductive structure (14) in the form of a printed circuit trace configured on the carrier substrate and conductively connected to the ground connection, and is set apart from the second electroconductive structure by a gap (16). (FIG. 4)

11. The device as recited in claim 10, wherein the contact element (3) is a contact element of a male connector arranged on the carrier substrate.

12. The device as recited in one of claims 2 through 5, wherein the mutually facing sections (13a, 14a) of the printed circuit traces (13, 14) and the gap (16), produced in a defined manner, are covered by an active or passive electrical component (5) applied on the carrier substrate (1). (FIG. 7, FIG. 8)

13. The device as recited in claim 12, wherein a first connecting terminal (5a) of the component (5) is electroconductively connected to the first printed circuit trace (13), and a second connecting terminal (5b) of the component (5) is electroconductively connected to the second printed circuit trace (14).

14. The device as recited in claim 12 or 13, wherein the component (5) is joined in its edge area to the carrier substrate (1) by an adhesive agent (7) which seals the intervening space between the component (5) and the carrier substrate (1).

15. The device as recited in one of the preceding claims, wherein the gap (16) is between 20 and 200 micrometers wide.

16. A carrier substrate having a device (10) for protecting an electrical and/or electronic component (2), arranged on the carrier substrate (1), from electrostatic discharges, as recited in one of the preceding claims.
